(19) United States
(12) Patent Application Publication
(10) Pub. No.: US 2002/0181055 A1
(43) Pub. Date: Dec. 5, 2002

(54) System and method for embedding control information within an optical wireless link

(76) Inventors: Grant Christiansen, Rochester, MN (US); Karl Kirk Northrup, Rochester, MN (US); Robert Clair Keller, Plano, TX (US); Jose Luis Melendez, Plano, TX (US); John Ling Wing So, Plano, TX (US)

Correspondence Address: TEXAS INSTRUMENTS INCORPORATED, P O BOX 655474, M/S 3999, DALLAS, TX, 75265

(21) Appl. No.: 09/923,510

(22) Filed: Aug. 6, 2001

Related U.S. Application Data
(60) Provisional application No. 60/285,466, filed on Apr. 20, 2001.

(51) Int. Cl. H04B 10/00

(52) U.S. Cl. 359/159; 359/172

(57) ABSTRACT

Optical wireless links communicate beam alignment information between them over a collimated, modulated light beam, without the requirement of a secondary channel. The alignment feedback signal can be formatted as control packets that are inserted between data packets traveling over the optical wireless channel, as control packets that are combined with the data packets, as a low frequency modulation of the light beam, or similar approaches. Alignment feedback signals are used by the device receiving the signal to align its light beam using a beam steering device, such as a micro-mirror device. Control signals preferably include x and y coordinate information relating to the position of both devices that are communicating, as well as time stamp, sample number, and similar synchronization information. Control packets are extracted from the data stream by a switch based upon the destination address of the control packets.

This Application claims benefit of U.S. Provisional Application No. 60/285,466 filed on Apr. 20, 2001 and entitled “System and Method for Embedding Control Information Within an Optical Wireless Link,” which patent application is hereby incorporated by reference.

### CROSS REFERENCE TO RELATED APPLICATION

The following co-pending, co-assigned patent applications are related to the present invention. Each of the applications is incorporated herein by reference.

| | Serial No. | Filing Date | Attorney Docket |
|---|---|---|---|
| | 09/621,385 | 7/21/2000 | TI-30713 |
| | 09/620,943 | 7/21/2000 | TI-30714 |
| | 60/234,074 | 9/20/2000 | TI-31437 |
| | 60/234,086 | 9/20/2000 | TI-31436 |
| (Japan) | 2000-275343 | 9/11/2000 | TI-31632 |
| | 60/234,081 | 9/20/2000 | TI-31444 |
| | 60/233,851 | 9/20/2000 | TI-31612 |
| | 60/271,936 | 2/26/2001 | TI-32675 |

### FIELD OF THE INVENTION

This invention relates generally to optical wireless communications, and more specifically, to providing embedded control information within the optical wireless link.

### BACKGROUND OF THE INVENTION

Modern data communications technologies have greatly expanded the ability to communicate large amounts of data over many types of communications facilities. This explosion in Communications capability not only permits the communications of large databases, but has also enabled the digital communications of audio and video content. This high bandwidth communication is now carried out over a variety of facilities, including telephone lines (fiber optic as well as twisted-pair), coaxial cable such as supported by cable television service providers, dedicated network cabling within an office or home location, satellite links, and wireless telephony.

Each of these conventional communications facilities involves certain limitations in their deployment. In the case of communications over the telephone network, high-speed data transmission, such as that provided by digital subscriber line (DSL) services, must be carried out at a specific frequency range to not interfere with voice traffic, and is currently limited in the distance that such high-frequency communications can travel. Of course, communications over “wired” networks, including the telephone network, cable network, or dedicated network, requires the running of the physical wires among the locations to be served. This physical installation and maintenance is costly, as well as limiting to the user of the communications network.

Wireless communication facilities of course overcome the limitation of physical wires and cabling, and provide great flexibility to the user. Conventional wireless technologies involve their own limitations, however. For example, in the case of wireless telephony, the frequencies at which communications may be carried out are regulated and controlled; furthermore, current wireless telephone communication of large data blocks, such as video, is prohibitively expensive, considering the per-unit-time charges for wireless services. Additionally, wireless telephone communications are subject to interference among the various users within the nearby area. Radio frequency data communication must also be carried out within specified frequencies, and is also vulnerable to interference from other transmissions. Satellite transmission is also currently expensive, particularly for bi-directional communications (i.e., beyond the passive reception of television programming).

A relatively new technology that has been proposed for data communications is the optical wireless network. According to this approach, data is transmitted by way of modulation of a light beam, in much the same manner as in the case of fiber optic telephone communications. A photoreceiver receives the modulated light, and demodulates the signal to retrieve the data. As opposed to fiber optic-based optical communications, however, this approach does not use a physical wire for transmission of the light signal. In the case of directed optical communications, a line-of-sight relationship between the transmitter and the receiver permits a modulated light beam, such as that produced by a laser, to travel without the waveguide of the fiber optic.

It is contemplated that the optical wireless network according to this approach will provide numerous important advantages. First, high frequency light can provide high bandwidth, for example ranging from on the order of 100 Mbps to several Gbps, using conventional technology. This high bandwidth need not be shared among users, when carried out over line-of-sight optical communications between transmitters and receivers. Without the other users on the link, of course, the bandwidth is not limited by interference from other users, as in the case of wireless telephony. Modulation can also be quite simple, as compared with multiple-user communications that require time or code multiplexing of multiple communications. Bi-directional communication can also be readily carried out according to this technology. Finally, optical frequencies are not currently regulated, and as such no licensing is required for the deployment of extra-premises networks.

These attributes of optical wireless networks make this technology attractive both for local networks within a building, and also for external networks. Indeed, it is contemplated that optical wireless communications may be useful in data communication within a room, such as for communicating video signals from a computer to a display device, such as a video projector.

It will be apparent to those skilled in the art having reference to this specification that the ability to correctly aim the transmitted light beam to the receiver is of importance in this technology. Particularly for laser-generated collimated beams, which can have quite small spot sizes (i.e. cross-sectional area), the reliability and signal-to-noise ratio of the transmitted signal are degraded if the aim of the transmitting beam strays from the optimum point at the receiver. Especially considering that many contemplated applications of this technology are in connection with equipment that will not be precisely located, or that may move over time, the need exists to precisely aim and controllably adjust the aim of the light beam.

Co-pending application Ser. No. 09/310,284, filed May 12, 1999, entitled “Optical Switching Apparatus”, commonly assigned herewith and incorporated herein by this reference, discloses a micro-mirror assembly for directing a light beam in an optical switching apparatus. The micro-mirror reflects the light beam in a manner that may be precisely controlled by electrical signals. The micro-mirror assembly includes a silicon mirror capable of rotating in two axes. One or more small magnets are attached to the micro-mirror itself; a set of four coil drivers are arranged in quadrants, and are current-controlled to attract or repel the micro-mirror magnets as desired, to tilt the micro-mirror in the desired direction.

Because the directed light beam, or laser beam, has an extremely small spot size, precise positioning of the mirror to aim the beam at the desired receiver is essential in establishing communication. This precision positioning is contemplated to be accomplished by way of calibration and feedback, so that the mirror is able to sense its position and make corrections.

Co-pending patent application Ser. No. 09/620,943 entitled “Optical Wireless Link,” commonly assigned herewith and incorporated herein by reference, discloses one approach to providing a feedback signal from the receiver to the transmitter over a secondary link. As disclosed in the application, the feedback and control signals are transmitted over a low bandwidth link, such as a radio frequency (RF) link or a twisted pair or similar physical link.

Another approach to providing a light beam alignment feedback signal to the transmitter is disclosed in co-pending patent application No. 60/234,081 entitled “Optical Wireless Networking with Direct Beam Pointing,” commonly assigned herewith and incorporated herein by reference. In that application, alignment feedback is provided passively by a receiver lens surrounded by a reflective annulus.

### SUMMARY OF THE INVENTION

In one aspect, the present invention provides a [TO BE COMPLETED ONCE THE CLAIMS ARE FINALIZED].

The preferred embodiments of the present invention provide the advantage of a low latency and potentially high data rate alignment feedback system.

Another advantage is that alignment control can be accomplished without the need for a secondary physical or RF channel for alignment feedback, and the concomitant cost and complexity of the secondary channel and in the case of RF, licensing issues.

### BRIEF DESCRIPTION OF THE DRAWINGS

The above features of the present invention will be more clearly understood from consideration of the following descriptions in connection with accompanying drawings in which:

FIG. 1 illustrates a preferred embodiment wireless optical communication system;

FIG. 2 is block diagram of a referred embodiment optical wireless link;

FIG. 3 is a block diagram of a preferred embodiment control logic for an optical wireless link;

FIGS. 4a and 4b illustrate the insertion of control packets into a data stream;

FIG. 5 illustrates a preferred embodiment control packet;

FIGS. 6a and 6b illustrate further details of the preferred embodiment control packet;

FIGS. 7a and 7b schematically illustrate preferred embodiment photodetectors;

FIG. 8 illustrates an optical transmitter and receiver embodiment wherein control signals are transmitted via low frequency modulation of the light beam;

FIG. 9 illustrates combining data packets and control packets into a non-standard packet protocol;

FIG. 10 illustrates a system wherein control signals are transmitted as voice over packet packets; and

FIG. 11 schematically illustrates a preferred embodiment optical module having beam steering capability.

### DETAILED DESCRIPTION OF ILLUSTRATIVE EMBODIMENTS

The making and use of the various embodiments are discussed below in detail. However, it should be appreciated that the present invention provides many applicable inventive concepts, which can be embodied in a wide variety of specific contexts. The specific embodiments discussed are merely illustrative of specific ways to make and use the invention, and do not limit the scope of the invention.

FIG. 1 illustrates a preferred embodiment optical wireless system 10, including a first data source/sink 2 connected to a first Optical Wireless Link (“OWL”) 4. The OWL 4 can both transmit to and receive data from a second OWL 6 over a wireless optical path. OWL 6 is in turn connected to a second data sink/source 8. Preferably each OWL device is an optical path-to-sight modem. As used herein, the term path-to-sight is intended to mean an unobstructed optical path generally through the ether, as contrasted with through an optic fiber, which path can include reflection. An advantageous feature of the OWL device is that the optical beam is a narrow, collimated light beam, such as provided by a laser or collimated laser diode. The narrow beam allows for a lower power laser source to be used, because the optical power is concentrated in a small area. While this provides an advantage in terms such as eye safety and lower power consumption, it provides a commensurate disadvantage that it is difficult to align the collimated light beam to the receiving photodetector (because of the relatively small beam size).

Data sink/sources 2, 8 could be any type of data device, such as a computer, a LAN network, an Ethernet device, a telephony device or switch, and the like. Data sink/sources 2, 8 communicate with OWLs 4, 6, respectively over a data connections 12, 14, respectively. These data connections (e.g., twisted pair, cable, fiber optic) are typically physical connections operating under a standard protocol, such as Ethernet, TCP/IP, ATM, and the like. Data connections 12, 14 could also be RF based wireless connections in some applications.

OWL 4 communicates with OWL 6 over a collimated light beam 16. OWL 4 has a field of view 18 and the receiver of OWL 6 must be positioned within the field of view 18 for effective communication. Likewise, OWL 6 has a field of view 22 in which it can transmit a collimated light beam 20 to the receiver of OWL 4. As described in greater detail in co-pending patent applications [TI30714], signal to noise ration (SNR) is maximized when the light beams 16, 20 are centered on the photo-receivers of the receiving units 6, 4, respectively. The alignment of the light beam can be detected as a function of received optical power, signal intensity, and the like and this detected alignment information can then be fed back to the transmitter. Also described in greater detail in co-pending patent application [TI-30714] is a preferred embodiment mechanism for controllably steering the light beam. In addition to or from data from data source/sink 8, OWL 6 transmits the light beam alignment feedback signals to OWL 4 over light beam 20. Likewise, OWL 4 transmits beam alignment feedback signals to OWL 6 over its light beam 16, in addition to data to or from data source/sink 2. Because light beams 16, 20 are high bandwidth, low latency paths, the transmission of feedback signals over the beams allows for rapid alignment of the beams (low latency) without degrading the data handling capabilities of the system (high bandwidth). In the preferred embodiments, OWL devices 4 and 6 communicate with each other using standard 100 Mb/s Ethernet protocol. The inventive concepts described herein apply equally to other communication protocols, including ATM, TCP/IP, SONET, IEEE 1394, IRDA, 10 Mb/s Ethernet, Gigabit Ethernet, and other alternatives that will be within the purview of one skilled in the art.

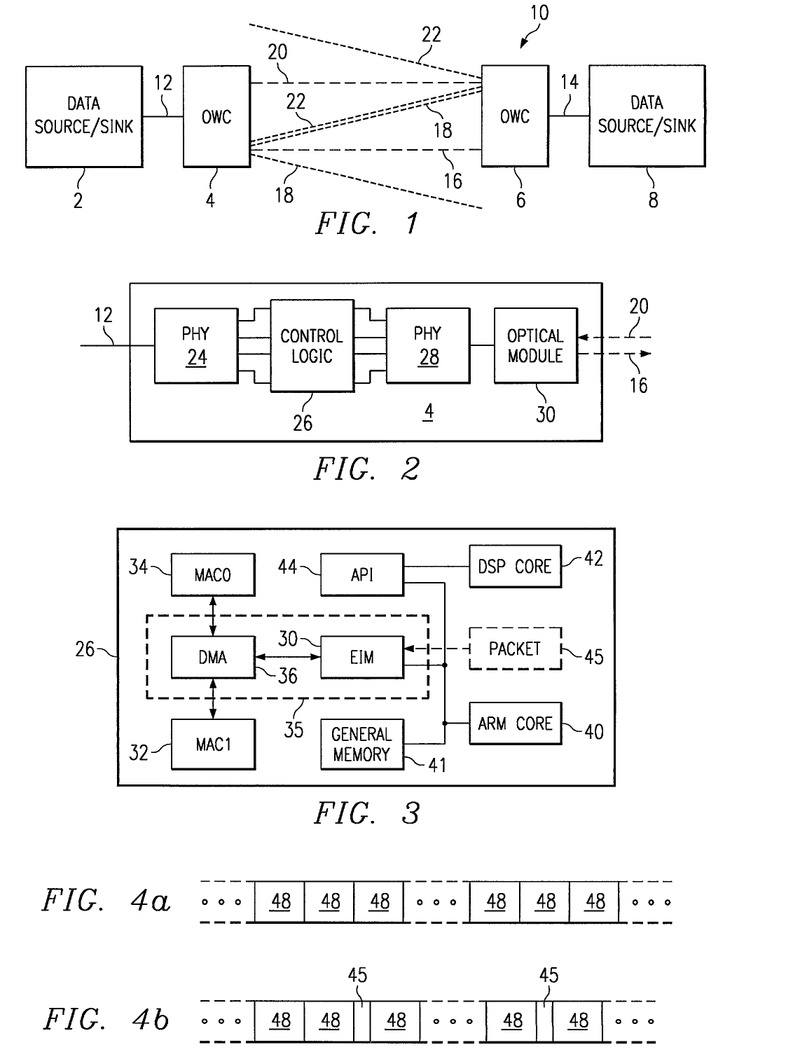

FIG. 2 provides further details for OWL 4. The following discussion applies equally to OWL 6. Data originating from data source/sink 2 and coming in over data connection 12 is received by PHY 24 where the data is converted from a serial format to a four bit parallel (MII) format, as is well known in the art. PHY 24 is a physical format converter that receives data in the format particular to the physical data connection to which it is attached and converts it into a media independent interface (MII) format that is not specific to a physical connection. From PHY 24, the data is passed to control logic 26 where the data may be encoded or decoded, supplemented with Operation/Administration/Maintenance (OAM) data, formatted for further transmission, enclosed within an appropriate network packet, or other data handling as is well known in the art. In addition, control logic 26 will read from the data stream certain control packets for light beam alignment, as will be discussed in greater detail below. A second PHY device 28 receives the data from control logic 26 and converts is from the parallel MII format into a serial format specific to optical data transmission. In the preferred embodiments, PHY 28 converts the data to a standard physical layer protocol for fiber optic transmissions (e.g., 100 Base-FX or SX). Other physical layer protocols, or a specialized optical wireless protocol could also be used. The data is then passed to optics module 30, where it is converted from an electrical format to an optical format and transmitted over light beam 16 to OWL 6, from where it will be transmitted to the appropriate destination such as data sink/source 8 by way of data connection 14.

OWL 4 operates as a receiver as well, in which case the data path is the opposite of that just described. Data from data sink/source 8 is processed by OWL 6 in the manner described above and transmitted optically to OWL 4 via modulated light beam 20. Optical module 30 detects the modulated light beam, converts it to an electrical signal, and passes the electrical signal to control logic 26. Control logic 6 inspects the incoming signal and reads from it any control packets relating to beam alignment feedback, as discussed in greater detail below. The data stream is passed from control logic 26 to PHY 24 where it is converted to the appropriate physical format for transmission to data sink/source 2 over data connection 12.

Further details of control logic 26, including the details of insertion and extraction of alignment feedback control signals will now be provided with reference to FIG. 3. In the preferred embodiment, control logic 26 comprises a TMS320VC5472 IP processor, available from Texas Instruments, Dallas, Tex., although the following described features could be embodied in discrete devices, other integrated components, specialized hardware, or general purpose hardware running under appropriate software control. Control logic 26 includes media access controller (MAC) 32, which is connected to PHY 24 (FIG. 2) and a second MAC 34 connected to PHY 28. As is well known in the art, the MACs have individual Ethernet addresses and are hence network addressable at the Ethernet protocol level. Connected between the MACs is an Ethernet switch 35 comprising direct memory access (DMA) 36 and Ethernet interface module (EIM) 38. The Ethernet switch 35 is responsible for detecting and extracting feedback control packets from the data stream as well as for inserting feedback control packets into the data stream. Feedback control packets are detected by Ethernet switch 35 on the basis of the Ethernet destination address contained within the packet, as will be discussed in greater detail below. Control packets are inserted into the data stream by storing incoming packets or frames of data in a buffer, and inserting a control packet between the data packets or frames, under the control of advanced RISC processor (ARM) core 40.

The operation of the control logic 26 is as follows. The optical module 30 of the receiving OWL detects the alignment of the incoming light beam and passes the detected alignment parameters (based upon optical power, intensity, or the like) to the digital signal processor (DSP) core 42 of the control logic 26 of the receiver OWL, preferably via Application Programming Interface (API) 44. DSP core 42 generates control signals from the detected alignment parameters to be fed back to the transmitting OWL. Further details regarding the control signals are provided below. Preferably, the DSP passes the control signals to the ARM core 40 for insertion into the data stream to be transmitted back to the transmitting OWL. As described in further detail below, ARM core 40 packages the control signals into a control packet 44 and provides the control packet 44 to Ethernet switch 35. FIG. 3 schematically illustrates an exemplary control packet 45 being passed to Ethernet switch 35 under the control of ARM 40, to be inserted into the data stream passing between MAC 32 and MAC 34. Ethernet switch 35 is responsible for inserting the control packet 44 into the data stream that has been received by way of MAC 32. The appropriate location is typically between packets or frames of the data being transmitted between data source/sink 2 and data source/sink 8.

The data stream consisting of the data packets and the interspersed control packets is then passed from Ethernet switch 35 to MAC 34 and thence to PHY 28 (FIG. 2), where the data stream will be converted to a serial optical format before being optically processed and transmitted by optical module 30.

FIGS. 4a and 4b illustrate schematically, the insertion of control packets 45 into a data stream 46. As shown in FIG. 4a, the stream of information passing between the two data source/sinks is organized as a series of data packets 48. These data packets 48 are defined by the protocol being used for communication between the data source/sinks. For instance, the data packets 48 may be based upon a standard Ethernet frame protocol, or based upon TCP/IP frames, ATM frames, FTP frames, SONET protocol frames, and the like, as will be apparent to one skilled in the art. Each frame may contain digital video, audio or graphics information, digital data, digitized analog information such as a voice signal, or any other type of data to be conveyed. In FIG. 4b, control packets 45 have been inserted by Ethernet switch 35 between two successive data packets 48. Because the control packets are inserted into the data stream to be transmitted over the optical wireless link, some bandwidth is consumed by this method. As will be discussed below, however, the bandwidth overhead is minimized by selecting a compact packet format for the control packets and by transmitting a minimum number of control packets.

In the preferred embodiments, a control packet 45 is inserted into the data stream 46 at a 4 kHz rate, i.e. once every 250 μs. The 4 kHz feedback rate is a matter of design choice and can be influenced by several factors. One factor is the rate at which the beam alignment can be detected by the receiving OWL. Another factor is the operating conditions in which the devices are operating (i.e. high traffic, high vibrations areas, or relatively stable areas). At 4 kHz, the devices can detect and respond to most mechanical vibrations, including someone bumping into the OWL or the fixture to which the OWL is mounted (which incident would result in some mechanical vibration with its primary frequencies at or below 4 kHz). Yet another factor is the acceptable level of bandwidth that can be consumed by transmitting the feedback control packets over the optical link. As described in greater detail below, each control packet 45 is preferably 64 bytes in length, resulting in an “overhead” load of approximately 2 Mb/s. For the preferred embodiment 100 Mb/s Ethernet embodiment, this is an approximately 2% overhead penalty arising from feeding back alignment over the optical link, rather than over a secondary channel. It is contemplated within the scope of the invention that the overhead load could be further reduced by adaptively varying the alignment packet rate. For instance, the receiving unit could be configured to detect periods when the beam alignment remains relatively stable and to reduce the frequency of control packet insertions accordingly. Alternatively, the OWL units could detect periods of peak data transmission and reduce the control packet rate during those peak periods. In still other embodiments, the control packets might be inserted only when an OWL detects that the beam alignment has begun to stray. Other approaches can be employed as well, and stay within the scope of the inventive concept described herein.

On the receiving end, the incoming optically transmitted data stream will be received by optical module 30 (referring once again to FIGS. 2 and 3, but bearing in mind that the following description relates to an OWL that is receiving the data stream transmitted by the above described OWL). Optical module 30 converts the incoming optical data stream into an electrical signal, which signal is received by PHY 28 and converted to the parallel MII format before being passed to MAC 34. The data stream passes through Ethernet switch 35, where each packet is examined. Ethernet switch 35 identifies control packets 45 and sends a copy of the control packet information to DSP 42 via ARM 40 for further processing. The data stream also passes through Ethernet switch 35 to MAC 32, where the data stream is processed for forwarding to PHY 24 and thence to data connection 12.

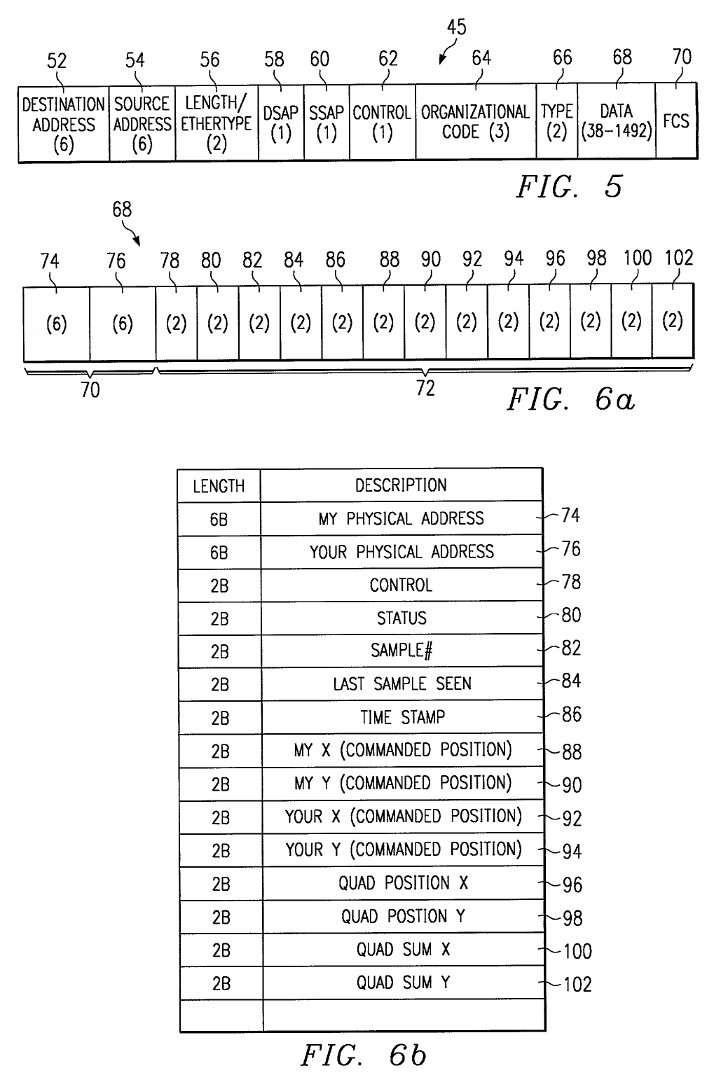

FIG. 5 provides further detail regarding a preferred embodiment control packet 45. The packet, defined in link level protocol, is preferably 64 bytes in length. Preferably the control packet is compliant with the IEEE 802.2 SubNetwork Access Protocol (SNAP). As shown, the SNAP packet contains a six byte destination address field 52 and a six byte source address field 54. These addresses are the 48-bit Ethernet hardware addresses of the receiving and sending unit, respectively. The two byte length/Ethertype field 56 designates the frame type. The protocol being used is defined by the single byte destination service access point (DSAP) and source service access point (SSAP) fields 58 and 60 , respectively. These fields define the protocol for controlling the routing of packets at the physical layer. Likewise, the control field 62 provides additional link layer control information. The three byte organizational code 64 is used to define proprietary packets. This three byte code is assigned to individual organizations by the IEEE to allow the organization to uniquely identify their SNAP packets. Data field 68 is variable in length from 38 to 1492 bytes. In the preferred embodiments, data field 68 is set as small as possible, to 38 bytes, in order to minimize bandwidth overhead. Finally, FCS field 70 is a frame check sequence. This field is used to perform cyclic redundancy check (CRC) on the incoming frame to check for errors, as is well known in the art.

The SNAP format provides the advantage of small size packets, hence minimizing bandwidth overhead. Additionally, the SNAP format can be employed without the need for a network stack because the protocol does not require an IP address look-up function. One skilled in the art will recognize that other standard protocols or even non-standard proprietary protocols could be employed in lieu of the SNAP protocol packets. For instance, in some embodiments, it may be preferable to format the control packets as TCP/IP packets. Such an alternative would be preferable in that IP packets can be configured to terminate upon reaching their destination (in this case, the control logic 26 of OWLs 2 and 6). This would prevent the control packet from passing through the OWL and onto the connected network or network device 2, 8. Furthermore, an IP protocol pre-supposes that the OWL would have an IP address. While this requires a network stack for the OWL, it also implies that the OWL would hence be “accessible” to the network from a network management standpoint.

A preferred arrangement of the data field 68, i.e. the actual control data, is provided in FIG. 6a. The 38 byte field is logically divided into a twelve byte MCU Header 70 that contains the physical addresses of the two units (i.e. the sending unit and the receiving unit) and a 26 byte Servo Header 72 that contains the control signals. FIG. 6b provides further detail regarding the logical organization of data field 68. As shown, the field contains two six bit fields, 74, 76, defining the physical address of the sending unit and the receiving unit, respectively. These comprise the MCU Header. The Servo Header comprises thirteen two-byte fields, including control field 78 and a two byte status field 80, which indicates the current mode of the OWL unit, such as seeking or tracking. The Servo Header also includes a sample field 80 that identifies the particular sample for which feedback is being provided and a “Last Sample Seen” 82 that identifies the last sample that was fed back. These fields can be used by the receiving unit to “recreate” its mirror position at the time the other unit last received a good optical signal. The “Time Stamp” field 84 also aids in this regard, and can be used by the receiving unit to “recreate” its mirror position at some previous point in time relative to the time stamp. The x and y coordinates of the light beam positioning for the sending unit is provided in the “My X” and “My Y” fields 88 and 90, respectively, and the x and y coordinates for the receiving unit are also sent in fields 92 and 94. This information ensures that the two devices have a common “understanding” of their relative positions to each other. Finally, four alignment parameters “Quad Position X,” “Quad Position Y,” “Quad Sum X,” and “Quad Sum Y” are also transmitted in fields 96, 98, 100, and 102, respectively. These parameters, which are used by the receiving unit to better align its beam position are described in greater detail in co-pending, commonly assigned patent application [TI-______], entitled “Method and Apparatus for Aligning Optical Wireless Links,” which patent application is incorporated herein by reference.

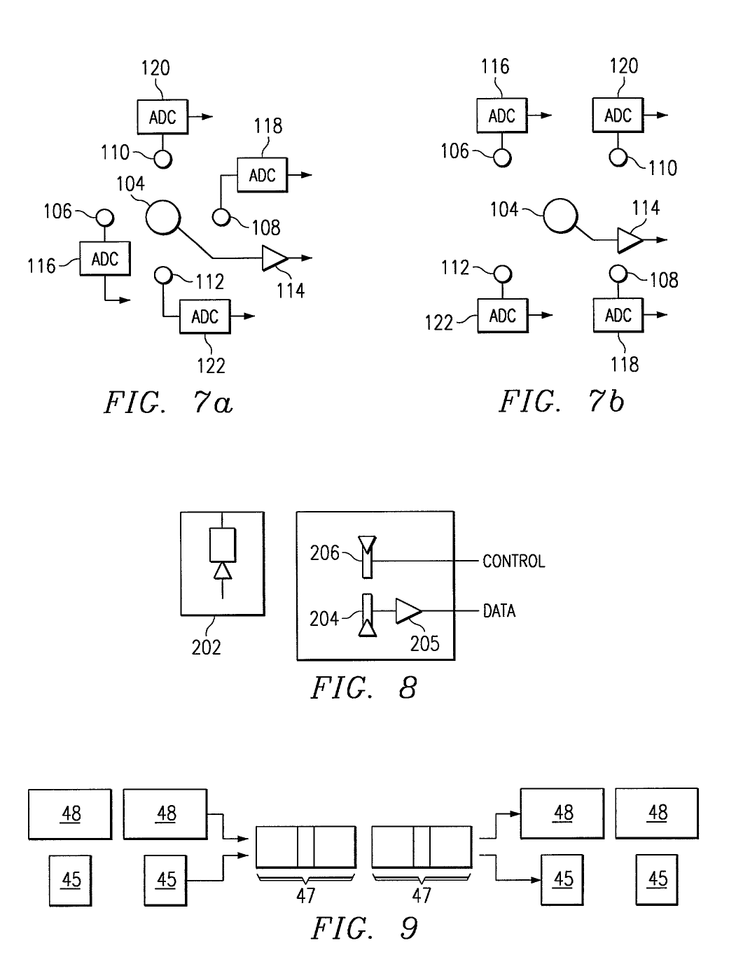

FIG. 7a schematically illustrates a preferred embodiment photodetector, such as would be employed in the optical module 30 of OWLs 4 and 6. The photodetector comprises a data detector 104 and four servo detectors, two along the x axis and two along the y axis and identified by reference numerals 106, 108, 100, and 112, respectively. Data detector 104 is preferably a Si PIN detector and is connected to a pre-amplifier 114 where the received signal is amplified before being passed to signal amplifying and processing circuitry (not shown) as is well known to those skilled in the art. Servo detectors 106-112 are preferably low bandwidth light-to-voltage converters containing an integrated amplifier such as a TAOS 254. Each servo detector is coupled to an analog to digital converter where the intensity of the light impinging upon the associated servo detector is converted into a digital value proportionate to the light intensity. By comparing the digital values from ADCs 116, 118, 120, and 122 (corresponding to the light intensity at servo detectors 106, 108, 110, and 112, respectively), the alignment of the impinging light beam relative the centrally located data detector can be determined. As an example, assuming the value being received from ADC 120 is higher than the value being received from ADC 122, this would indicate that the light beam is misaligned and in impinging above the center of data detector 104. By feeding this information back to the transmitter, as described above, the beam can be re-positioned to impinge lower upon data detector 104. Likewise, if the value being received from ADC 122 is higher than for ADC 120, this would indicate that the beam is too low and needs to be adjusted upwards. As discussed above, these parameters are fed back to the transmitting unit wherein the light beam is re-directed to more precisely align the beam. Further details on the steering of the light beam are provided in co-pending patent application Ser. No. 09/620,943.

FIG. 7b illustrates another preferred embodiment configuration for the photodetector, wherein the servo detectors are located on 45° axes relative the centrally located data detector 104. This configuration is preferable in that two detectors can be used for determining the alignment in the x axis and two detectors for determining alignment in the y axis. In other words, under the configuration illustrated in FIG. 7b, the relative value of both servo detectors 108 and 110 compared to both 106 and 112 would be used for alignment in the x direction, and the relative value of servo detectors 106 and 110 to servo detectors 108 and 112 would be compared for alignment in the y direction.

At the receiving end, the alignment control feedback signal is received and converted into alignment commands to the optical module. These alignment commands are directed to a movable mirror that can be used to steer the light beam being transmitted. One embodiment of an optical module 30 is provided in FIG. 11. The module includes an Encoder/Decoder Unit 320, coupled by a two-way Data Link 322 to an Optical Transceiver Unit (OUT) 324. The OTU 324 acts as an electrical to light and light to electrical converter. It contains a light source, such as a laser or light emitting diode, control electronics for the light source, a photo-detector for converting the received light to electrical signals and amplifiers to boost the electrical strength to that compatible with the decoder.

The OTU 324 can also be of conventional design. For example, a TTC-2C13 available from TrueLight Corporation of Taiwan, R.O.C., provides an advantageous and low cost optical transceiver unit, requiring only a single +5V power supply, consuming low power, and providing high bandwidth. However, it should be noted that OTU units of conventional design can provide less than optimal performance, since such units are typically designed for transmitting and receiving light from fibers. This results in three problems that should be noted by the designer. First, light is contained in such units and is thus not subject to the same eye safety considerations as open air optical systems such as the present invention. Consequently, such units may have excessively high power. Second, light is transmitted to a fiber and thus has optical requirements that are different from those where collimation is required, as in embodiments of the present invention. Third, light is received by such units from a narrow fiber, and therefore such units usually have smaller detector areas than desired for embodiments of the present invention. Accordingly, it is considered preferable to assemble a transceiver having a photodiode and optical design such that the maximum amount of light is collected from a given field of view. This requires as large a photodiode as possible, with the upper limit being influenced by factors such as photodiode speed and cost. In any event source, a preferred light source is a vertical cavity surface emitting laser, sometimes referred to as a VCSEL laser diode. Such laser diodes have, advantageously, a substantially circular cross-section emission beam, a narrow emission cone and less dependence on temperature.

The Optical Transceiver Unit 324 is coupled by a two-way data link 326 to Optics 328. The Optics 328 contains optical components for collimating or focusing the outgoing light beam 16 from the transceiver, a micro-mirror controlled by, e.g., electromagnetic coils, for directing the collimated light in the direction of a second OWL (not shown), with which OWL is in communication, and receiving optics to concentrate the light received from the second OWL on a transceiver photodetector included in the Optics 328. The receiving optics can include a control mirror, either flat or curved, to direct the light to the photodetector. Auxiliary photo detectors can be provided adjacent to the main photodetector for light detection in connection with a control subsystem (not shown), for controlling the control mirror, and maximize the light capture at the photodetector. The Optics 328 may also contain a spectral filter 330 to filter ambient light from the incoming signal light 20. The Optics 328 is preferably, but need not be a micro-mirror. Any controllable beam steering device can be used that changes the direction of the light beam without changing the orientation of the light emitter. In addition, a basic function of the Optics 328 is that it sufficiently collimates the light beam that will (1) substantially fit within the micro-mirror reflecting area, and (2) preserve the minimum detectable power density over the distance of the link. Laser diodes generally meet these criteria, and as such are preferred. However, light emitting diodes (LEDs) and other light sources can be made to satisfy these criteria as well.

For optical wireless links across large distances where the highest possible optical power density at the receiver is needed for robust transmission, the optical portion of the preferred embodiments should preferably be selected to achieve a divergence of less than 0.5 mrad, which is to be contrasted with the prior art system that have divergences in the range of 2.5 mrad. The divergence of less than 0.5 mrad results in an optical density greater than 25 times the optical density of the prior art systems, which, for the same received optical power density corresponds to 5 or more times longer range.

The optical receiver portion of this embodiment should be selected to have an intermediate size, preferably having a diameter in the range of 0.5 millimeter (mm) to 1 centimeter (cm). If the diameter is much smaller than 0.5 mm, it may be difficult to collect enough of the light directed on the receiver. On the other hand, if the diameter is much larger than 1 cm, the responsiveness of the detector may diminish to the point where the performance of the system is compromised.

It should also be understood that more than one Optical Transceiver Unit 324 may be provided in some embodiments, for example to provide multiple wavelengths to transmit information across a single link, in order to increase the bandwidth of a given OWL link. This involves generating light beams having multiple wavelengths and collecting and separating these separate light beams. Numerous apparatus and methods are known in the art to accomplish this.

The Optics 328 are coupled by an optical path 332 to a Position Sensitive Detector (“PSD”) 334. The PSD 334 measures the angular deflection of the micro-mirror in two planes. This can be accomplished by detecting the position of a spot of light on a sensor in the PSD 334. The analog signals representing these angular deflections are converted into signals and sent on lines 336 to a Digital Signal Processor (“DSP”) 42 for closed loop control of the micro-mirror in Optics 328. PSDs are well known in the art, and PSD 334 may be any of a variety of types, including a single diode Si PSD, CMOS photo-detector array, and the like. All that is required of PSD 334 is that it sense, in two directions, the position of a spot of light impinging thereon, and provide as outputs digital signals representative of such position. However, note that the use of analog control signals is not required in the practice of the present invention. Other known control signal approaches can be used. For example, pulse-width modulation may be used to provide such control. Such choices of control system are well within the purview of those of ordinary skill in this art. A preferable approach to micro-mirror position detection is to employ sensors on the actual micro-mirror itself, as described in greater detail in co-pending and commonly assigned patent applications No. 60/233,851 (“Packaged Mirror with In Package Feedback”) and No. 60/234,081 (“Optical Wireless Networking with Direct Beam Pointing”), which applications are incorporated herein by reference.

In addition to receiving the signal lines 336 from the PSD 334, the DSP 42 sends coil control signals on lines 340 to a set of coil digital to analog converters (“D/As”) 342. The D/As 342 are, in turn, connected by way of lines 344 to a corresponding set of coils in Optics 328. Finally, the DSP 42 is connected via line 352 to send and receive OAM data to/from Encoder/Decoder 320. The DSP 42 operates as a link control. It controls the micro-mirror deflections by controlling the coil currents through the D/As 342. Information on the instantaneous micro-mirror deflections is received from the PSD 334 for optional closed loop control. The DSP 42 also exchanges information to the second OWL to orient the beam steering micro-mirror in the proper direction for the link to be established and maintained. The DSP may also exchange OAM information with the second OWL across the optical link maintained by Optical Module 328. DSP 42 may be any suitable DSP, of which many are commercially available. Preferably, the DSP is the DSP provided for by control logic 26, as discussed above, although a second distinct DSP could optionally be used. In addition, note that a single processor may control multiple OWL links. This capability can be very valuable for use in a network hub, where multiple links originate or terminate in a single physical network switch. A single DSP could provide a very cost efficient control facility in such cases. In all such cases, the requirements for this processor are a sufficiently high instruction processing rate in order to control the specified number of micro-mirrors, and a sufficient number of input/output (“I/O”) ports to manage control subsystem devices and peripheral functions.

In an alternative embodiment, the alignment information can be fed back to the transmitting unit in other ways than as a separate control packet. For instance, in one embodiment, the alignment information can be imposed upon the optical beam itself using low frequency, small signal modulation. Such an embodiment is illustrated in FIG. 8. This embodiment takes advantage of the fact that optical communications generally use encoding schemes (such as 4B/5B encoding) that do not generate frequencies below a certain range. The low frequency bandwidth is therefore available for transferring low bandwidth data without interfering with the link data. The amplitude of the control data modulation needs to be a small fraction of the overall signal amplitude, or else the main data path signal to noise ration will decrease significantly. the control data could be encoded/decoded directly by the DSP 42.

The optical signal with both the high frequency data signal and low frequency control signal can be generated using a laser driver and photodiode 202 such as the AD9660, available from Analog Devices, Norwood, Mass., where the write pulse modulates the high speed data and the bias and write levels modulate the low frequency small signal control data.

At the receiver, the control data can be separated from the main link data several ways. If only one photodiode is used, the control data can be extracted with a low pass filter (or low frequency band pass filter to avoid very low frequencies) and a high pass electrical filter can be used to separate the main link data. Alternatively, as shown in FIG. 8, a separate photodiode (or multiple photodiodes) could be used such that the optical beam illuminates both the main link high speed phtotodiode 204 connected to a high pass filter 205 and the low bandwidth control data monitoring photodiode 206. The control data monitoring photodiode 206 can be much more sensitive because the control data requires a much lower bandwidth.

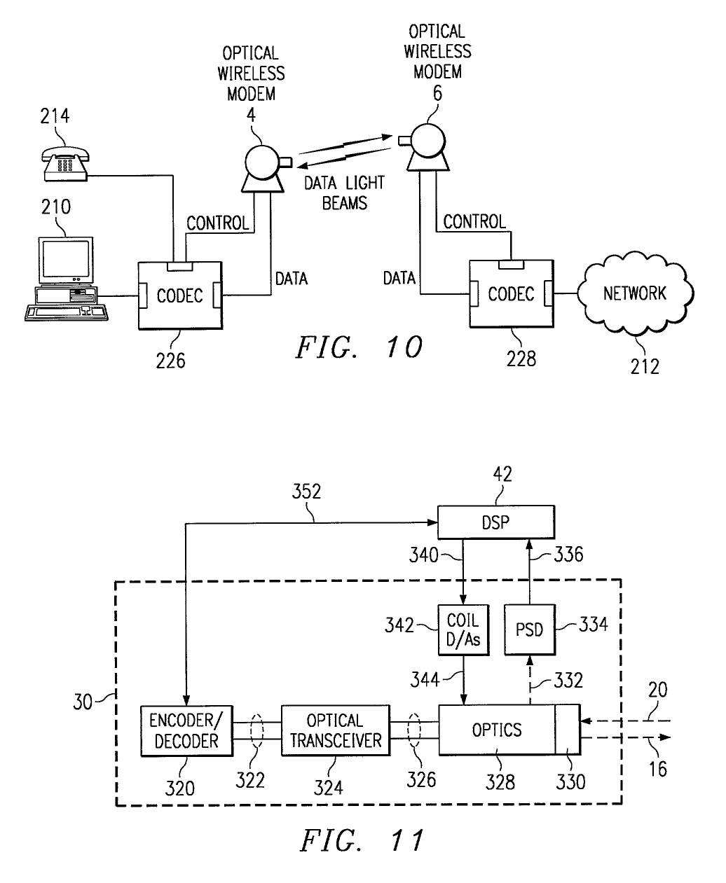

In another alternative embodiment, the control packets and the data packets can be interleaved into a new higher rate data stream, as illustrated in FIG. 9. As shown, data packets 48 and control packets 45 can be combined into a unique packet form 47 for transmission across the optical link. Because each packet 47 contains control (i.e. feedback) information, this approach would have a lower latency than the first preferred embodiment, wherein control information is inserted where it can be fit into the data stream. On the receiving side, the packet 47 is resolved into its constituent data packet and control packet components for processing as described above. This approach requires a non-standard protocol and hence would be protocol dependent, if implemented.

Yet another approach is to “disguise” the control packet as a normal data packet of the data stream. One example would be in a system wherein the OWL devices are transmitting using a Voice over Packet (VOP) protocol, although the concept would apply to other protocols as well. Such an embodiment is illustrated in FIG. 10, wherein a first network device 210 communicates with a network over a optical wireless link employing two OWLs 4 and 6. In the illustrated embodiment, telephone communications also take place over the link, originating with telephone device 214. VOP processing circuitry 226 receives both data and telephone signals and transmits them as data to OWL 4 in addition to transmitting control information. The data is transmitted as VOP packets. In this embodiment, the control information is also formatted in a similar manner to appear as a VOP packet and inserted into the data stream. On the receiving end, data and control is passed to VOP processing circuitry 228 where the control VOP packets are extracted from the packet stream (based upon the destination address) for alignment of the beam of OWL 6, and the data streams is then passed to network 212.

As will be apparent from the above description, the preferred embodiments provide several advantageous features including the ability of feed back beam alignment information to the transmitting unit without the need for a secondary channel such as an RF or physical channel. The preferred embodiments also provide the advantage of a very low latency feed back system, as the optical wireless channel provides for rapid transmission and high bandwidth.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method of aligning two optical wireless links, comprising:
detecting the alignment of a first modulated light beam and generating a first alignment feedback signal, the first modulated light beam having been transmitted by a first optical wireless link;
transmitting the first alignment feedback signal to the first optical wireless link over a second modulated light beam;
detecting the alignment of the second modulated light beam and generating a second alignment feedback signal; and
transmitting the second alignment feedback signal over the first modulated light beam.

2. The method of claim 1 further comprising:
adjusting the alignment of the first modulated light beam in response to the first alignment feedback signal; and
adjusting the alignment of the second modulated light beam in response to the second alignment feedback signal.

3. The method of claim 1 further comprising formatting the first and second alignment feedback signals as packets of data and inserting the first and second alignment feedback signals into first and second data streams, respectively, traveling over said first and second modulated light beams respectively.

4. The method of claim 1 wherein the first and second alignment feedback signals include x and y positions for the first and second modulated light beams, respectively.

5. The method of claim 1 wherein said steps of detecting comprise comparing the relative intensity of the light beam at a plurality of photodetectors.

6. The method of claim 1 wherein said steps of transmitting comprise transmitting data using a 100 Mb/s Ethernet protocol.

7. The method of claim 1 further comprising:
extracting said first alignment feedback signal from a data stream transmitted over said second modulated light beam; and
extracting said second alignment feedback signal from a data stream transmitted over said first modulated light beam.

8. The method of claim 7 wherein said first and second alignment feedback signals are transmitted as control packets and said extracting steps comprise detecting a destination address within said control packets.

9. An optical wireless link comprising:
a photodetector configured to receive a modulated light beam;
the modulated light beam conveying data;
a control circuit coupled to the photodetector, the control circuit receiving the data conveyed by the modulated light beam, and extracting therefrom embedded control information;
a processor coupled to the detector and receiving therefrom the control information and generating in response thereto beam alignment signals;
a beam transmitter coupled to the processor and receiving therefrom the beam alignment signals;
the beam transmitter adjusting alignment of a light beam in response to the beam alignment signals.

10. The optical wireless link of claim 9 further comprising:
a servo detector adjacent the photodetector and configured to detect light intensity information; and
a control information generator coupled to the servo detector and configured to generate control information from the light intensity information received from the servo detector; and wherein
the control circuit embeds the control information into data to be conveyed by the beam transmitter.

11. The optical wireless link of claim 9 wherein said conveyed data is formatted as data packets and wherein the control information is formatted as control packets interspersed with the data packets.

12. The optical wireless link of claim 11 wherein said control logic comprises a switch configured to detect control information on the basis of a destination address contained within the control packet.

13. The optical wireless link of claim 11 wherein the data packets are Ethernet frames and wherein the control packets are SubNetwork Access Protocol packets.

14. The optical wireless link of claim 10 wherein the optical wireless device receives control information relating to alignment of its beam transmitter and generates control information relating to alignment of a remote optical wireless link.

15. A method of receiving information at an optical detector comprising:
receiving optical information at an optical detector;
converting the optical information into electrical information;
determining whether the electrical information is control information;
adjusting an optical transmitter based on the control information.

16. The method of claim 15 further comprising passing the electrical information to a destination device.

17. The method of claim 15 wherein the step of adjusting an optical transmitter comprises adjusting the alignment of a light beam.

18. The method of claim 15 wherein the optical information is transmitted on a modulated, collimated light beam.

19. The method of claim 15 wherein the optical information comprises data to be conveyed to a data sink/source and control information.

20. The method of claims 15 wherein the step of receiving the optical information comprises detecting a modulated light beam with a photodetector.

21. The method of claim 15 wherein the step of determining whether the electrical information is control information comprises reading the destination address of the electrical information.

22. A system for communicating a data stream between a first and second data devices comprising:
a first data source/sink generating a stream of data packets;
a first optical wireless device coupled to receive the stream of data packets from the first data source/sink and including:
a switch configured to receive the stream of data packets and to insert therein alignment control packets;
a light beam transmitter coupled to the switch and configured to transmit the stream of data packets and control packets on a modulated light beam;
a second optical wireless device comprising:
a photodetector configured to receive the modulated light beam;
a second switch configured to receive the stream of data packets and control packets from the photodetector and to extract therefrom the control packets;
a second light beam transmitter; and
a light beam transmitter alignment unit coupled to the second light beam transmitter and configured to align the second light beam transmitter in response to the control packets; and
a second data source/sink coupled to the second optical wireless device and receiving therefrom the stream of data packets.

23. The system of claim 22 wherein at least one of the first data source/sink and the second data source/sink is a computer network.

24. The system of claim 22 wherein at least one of the first data source/sink is a telephone.

25. The system of claim 22 wherein at least one of the first data source/sink is a computer.
